(19) United States
(12) Patent Application Publication
(10) Pub. No.: US 2026/0042107 A1
(43) Pub. Date: Feb. 12, 2026

(54) ELECTROMAGNETIC EJECTION DEVICE

(71) Applicant: CHIA-HSIANG HUNG, TAIPEI CITY (TW)

(72) Inventors: LI KANG, Kunshan City (CN); JIANMIN LI, Kunshan City (CN); CHUANWEI CHE, Kunshan City (CN)

(21) Appl. No.: 19/294,349

(22) Filed: Aug. 8, 2025

(30) Foreign Application Priority Data
Aug. 12, 2024 (CN) 202411097445.6

(51) Int. Cl. B05B 1/30; F16K 31/06

(52) U.S. Cl. CPC B05B 1/3013; F16K 31/0675; F16K 2200/30

(57) ABSTRACT

The present disclosure relates to an electromagnetic jetting device, comprising a support frame, a material cartridge, and an electromagnetic jetting valve. The electromagnetic jetting valve comprises a valve body, a valve stem, and a driving assembly including a first magnet fixed relative to the valve body and a second magnet fixed relative to the valve stem, at least one of which is an electromagnet. When current flows in a clockwise direction through the electromagnet, a first magnetic force between the first and second magnets drives the valve stem away from the nozzle orifice; when the current direction is reversed to anticlockwise, a second magnetic force drives the valve stem toward the nozzle orifice. This arrangement enables jetting of high-viscosity liquid solely by reversing the current direction without altering the device structure.

### CROSS-REFERENCE TO RELATED APPLICATIONS

This application claims the benefit of Chinese Invention Patent Application No. 202411097445.6, filed on 12 Aug. 2024, the entire disclosure of which is hereby incorporated by reference.

### BACKGROUND

The present disclosure relates to the technical field of fluid dispensation, and in particular, to an electromagnetic jetting device.

High-precision liquid dispensation technology needs to be used in fields such as new energy resources, micro electro mechanical systems (MEMS), Nanoelectromechanical systems (NEMS), biochemical engineering, and printed circuit board (PCB) manufacturing. The high-precision liquid dispensation technology refers to dispensing various fluids with microliter or nanoliter volumes to designated positions of target materials, to meet the requirements of high-precision liquid dispensation. Especially in the field of printed circuit board manufacturing, high-viscosity liquid needs to be used as a medium to perform high-precision liquid dispensation.

The current electromagnetic jetting device relies on a reciprocating motion of a valve stem for liquid jetting. A solenoid valve closes when being energized, to lift the valve stem to allow liquid into a valve cavity. When the solenoid valve is de-energized, the valve stem resets under spring force of a spring, and the liquid in the valve cavity is jetted out from a nozzle under the action of the valve stem. During actual use, limited by the size of a valve body, the spring force and the stiffness of the spring cannot be infinitely increased, and the liquid is jetted only by the spring force of the spring, with limited energy. Especially when high-viscosity liquid is jetted, a part of the spring force of the spring needs to overcome motion resistance of the high-viscosity liquid. Consequently, the spring force used for jetting is smaller, and jetting effect of the high-viscosity liquid is poor. Providing an electromagnetic jetting device that may be used to jet high-viscosity liquid is an urgent technical problem to be solved in this field.

### SUMMARY

For this purpose, the present disclosure provides an electromagnetic jetting device, which may be used to jet high-viscosity liquid.

To resolve the technical problem, the present disclosure provides an electromagnetic jetting device, including a support frame, a material cartridge, and an electromagnetic jetting valve, the material cartridge is connected to the support frame, the material cartridge is configured to store dispensing liquid, and the electromagnetic jetting valve includes:
a valve body, the valve body being connected to the support frame, the valve body being provided with a valve cavity extending along a first direction, the valve cavity having a liquid inlet and a nozzle orifice, the liquid inlet being configured for the dispensing liquid to enter the valve cavity, the liquid inlet communicating with the material cartridge, and the nozzle orifice being configured for the dispensing liquid in the valve cavity to be jetted out;
a valve stem, the valve stem extending along the first direction and including a valve stem head and a valve stem tail respectively close to two ends of the valve stem in a lengthwise direction, the valve stem head being located in the valve cavity, and the valve stem head being capable of moving towards and away from the nozzle orifice along the first direction; and
a driving assembly, the driving assembly including a first magnet and a second magnet, the first magnet being relatively fixed to the valve body, the second magnet being relatively fixed to the valve stem, and at least one of the first magnet and the second magnet being an electromagnet, where when a direction of a current flowing through the electromagnet is a clockwise direction, a first magnetic force is generated between the first magnet and the second magnet, and drives the valve stem to move away from the nozzle orifice, and when the direction of the current flowing through the electromagnet is an anticlockwise direction, a second magnetic force is generated between the first magnet and the second magnet, and drives the valve stem to move towards the nozzle orifice.

Further, both the first magnet and the second magnet are disposed outside the valve cavity. Further, both the first magnet and the second magnet are electromagnets.

Further, the second magnet is connected to the valve stem tail, the first magnet, the second magnet, and the valve stem are sequentially disposed along the first direction, the first magnetic force is an attractive force, and the second magnetic force is a repulsive force.

Further, the driving assembly further includes an elastic component, and an elastic resetting force of the elastic component acts on the valve stem and drives the valve stem to move towards the nozzle orifice.

Further, the elastic component is a spring, the spring is sleeved over the valve stem, and the spring is located in the valve cavity.

Further, a sealing component for sealing a gap between the valve stem and the valve cavity is disposed, the sealing component separates the valve cavity into a first cavity portion and a second cavity portion, the liquid inlet and the nozzle orifice communicate with the first cavity portion, and the spring is located in the second cavity portion.

Further, the first magnet is connected to the valve body by using an adjustment component, and the adjustment component adjusts a position of the first magnet along the first direction.

Further, the nozzle orifice is disposed at one end of the valve cavity in the first direction, the liquid inlet is disposed at one end of the valve cavity in a second direction, the liquid inlet is close to the nozzle orifice, and the first direction and the second direction are perpendicular to each other.

Further, the valve stem head is in a shape of a bullet head, the nozzle orifice is a conical bore, a tip of the valve stem head faces towards the nozzle orifice, and an opening of one end of the nozzle orifice close to the valve stem head is larger than an opening of one end of the nozzle orifice away from the valve stem head.

Compared with the existing technology, the technical solutions of the present disclosure have the following advantages:
(1) According to the electromagnetic jetting device of the present disclosure, a current direction of an electromagnet is changed, to change a magnetic pole direction of a first magnet or a second magnet, so that the first magnet and the second magnet may attract each other, or repel each other. In this way, driven by a magnetic force between the first magnet and the second magnet, a valve stem head moves towards and away from a nozzle orifice. When the valve stem head moves towards the nozzle orifice, dispensing liquid is pushed to be jetted out from a valve cavity, and when the valve stem head moves away from the nozzle orifice, the dispensing liquid enters the valve cavity. The present disclosure realizes the purpose of pushing high-viscosity liquid to be jetted out only by changing the current direction without changing a structure of the electromagnetic jetting device;
(2) According to the electromagnetic jetting device of the present disclosure, both the first magnet and the second magnet are installed outside the valve cavity, to facilitate installation, maintenance, and adjustment of the first magnet and the second magnet. In addition, sizes of the first magnet and the second magnet are not limited by the valve cavity;
(3) According to the electromagnetic jetting device of the present disclosure, both the first magnet and the second magnet are electromagnets, and a magnitude(s) of magnetic force and a magnetic field direction(s) of the first magnet and/or the second magnet may be adjusted as required;
(4) According to the electromagnetic jetting device of the present disclosure, the first magnet, the second magnet, and the valve stem are sequentially arranged along a first direction. The layout is more proper, and installation is easier;
(5) According to the electromagnetic jetting device of the present disclosure, an elastic component is disposed, and spring force and magnetic force jointly drive the valve stem head to move towards the nozzle orifice, to jointly push the high-viscosity liquid to be jetted out, thereby further ensuring that the highly-viscosity liquid can be jetted out;
(6) According to the electromagnetic jetting device of the present disclosure, the elastic component is set as a spring, and the spring is set in the valve cavity. The spring has a relatively large spring force and a relatively small volume, so that the electromagnetic jetting device is more compact;
(7) According to the electromagnetic jetting device of the present disclosure, a sealing component is disposed to separate the valve cavity, so that it is not easy for dispensing liquid to leak out;
(8) According to the electromagnetic jetting device of the present disclosure, an adjustment component is disposed to adjust a position of the first magnet, to adjust a stroke of the valve stem as required;
(9) According to the electromagnetic jetting device of the present disclosure, the nozzle orifice is disposed at one end of the valve cavity in the first direction, a liquid inlet is disposed at one end of the valve cavity in a second direction, and it is easier for the dispensing liquid to enter the valve cavity and to be jetted out from the valve cavity when the valve stem moves; and
(10) According to the electromagnetic jetting device of the present disclosure, the valve stem head is in a shape of a bullet head, the nozzle orifice is a conical bore, and it is easier for the valve stem head to push the high-viscosity liquid to enter the conical bore.

### BRIEF DESCRIPTION OF THE DRAWINGS

To make the content of the present disclosure easier to be understood clearly, the following further describes the present disclosure in detail according to specific embodiments of the present disclosure with reference to the accompanying drawings.

FIG. 1 is a schematic diagram of an electromagnetic jetting device according to the present disclosure;

FIG. 2 is a schematic diagram of an electromagnetic jetting device during liquid entering according to the present disclosure; and FIG. 3 is a schematic diagram of an electromagnetic jetting device during liquid jetting according to the present disclosure.

### DESCRIPTIONS OF REFERENCE NUMERALS IN THE SPECIFICATION

1. Support frame; 2. Material cartridge; 3. Valve body; 31. Valve cavity; 32. Liquid inlet; 33. Nozzle orifice; 4. Valve stem; 5. First magnet; 6. Second magnet; 7. Elastic component; 8. Sealing component; and 9. Adjustment component.

### DETAILED DESCRIPTION

The present disclosure is further described below with reference to the accompanying drawings and specific embodiments, so that a person skilled in the art can better understand and implement the present disclosure. However, the embodiments provided are not intended to limit the present disclosure.

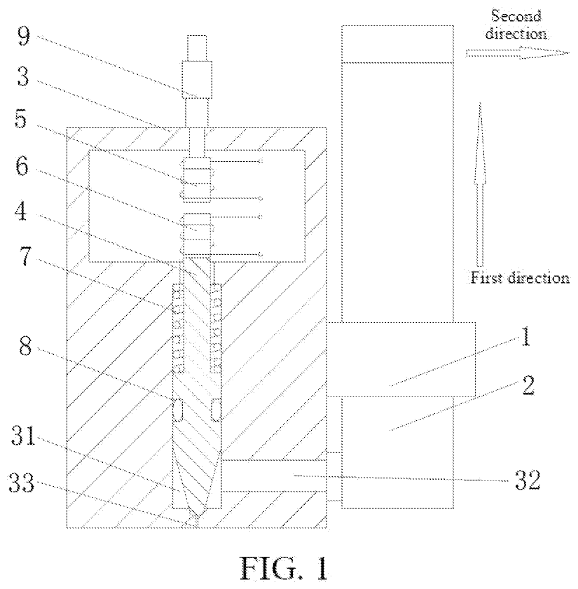

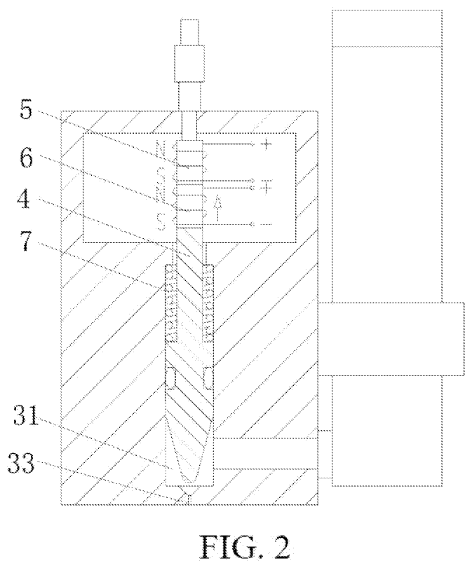

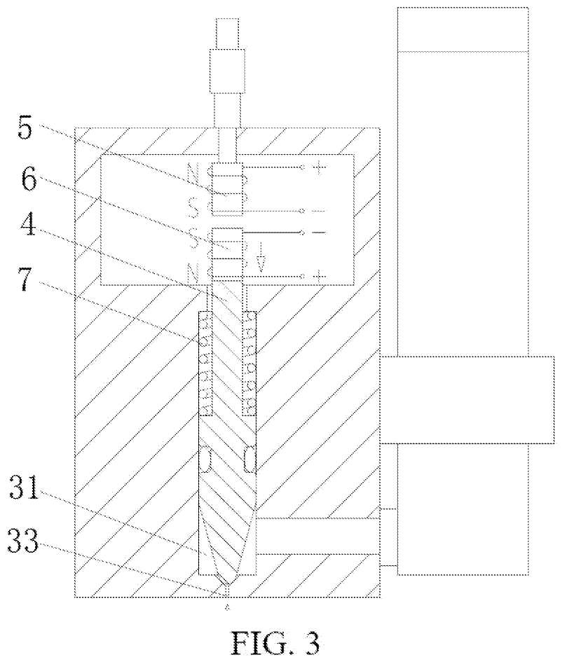

FIG. 1 to FIG. 3 show an embodiment of an electromagnetic jetting device provided in the present disclosure.

The electromagnetic jetting device includes a support frame 1, a material cartridge 2, and an electromagnetic jetting valve, the material cartridge 2 is connected to the support frame 1, the material cartridge 2 is configured to store dispensing liquid, and the electromagnetic jetting valve includes:
a valve body 3, the valve body 3 being connected to the support frame 1, the valve body being provided with a valve cavity 31 extending along a first direction, the valve cavity 31 having a liquid inlet 32 and a nozzle orifice 33, the liquid inlet 32 being configured for the dispensing liquid to enter the valve cavity 31, the liquid inlet 32 communicating with the material cartridge 2, and the nozzle orifice 33 being configured for the dispensing liquid in the valve cavity 31 to be jetted out;
a valve stem 4, the valve stem 4 extending along the first direction and including a valve stem head and a valve stem tail respectively close to two ends of the valve stem 4 in a lengthwise direction, the valve stem head being located in the valve cavity 31, and the valve stem head being capable of moving towards and away from the nozzle orifice 33 along the first direction; and
a driving assembly, a first magnet 5, and a second magnet 6, the first magnet 5 being relatively fixed to the valve body 3, the second magnet 6 being relatively fixed to the valve stem 4, and at least one of the first magnet 5 and the second magnet 6 being an electromagnet, where when a direction of a current flowing through the electromagnet is a clockwise direction, a first magnetic force is generated between the first magnet 5 and the second magnet 6, and drives the valve stem 4 to move away from the nozzle orifice 33, and when the direction of the current flowing through the electromagnet is an anticlockwise direction, a second magnetic force is generated between the first magnet 5 and the second magnet 6, and drives the valve stem 4 to move towards the nozzle orifice 33.

When the valve stem head moves away from the nozzle orifice 33, that is, the valve stem head moves in a direction away from the nozzle orifice 33, the dispensing liquid in the material cartridge 2 is drawn into the valve cavity 31 from the liquid inlet 32, and when the valve stem head moves towards the nozzle orifice 33, that is, the valve stem head moves in a direction close to the nozzle orifice 33, the dispensing liquid in the valve cavity 31 is jetted out from the nozzle orifice 33.

The electromagnet is a device that is energized to generate electromagnetism. A conductive winding matching a power of an iron core is wound outside the iron core. Such a coil through which a current passes has magnetism like a magnet, and is also referred to as an electromagnet. The electromagnet has magnetism when being energized, and the magnetism disappears after the electromagnet is de-energized. Presence or absence of the magnetism of the electromagnet may be controlled by on-off current; the magnitude of the magnetism may be controlled by the strength of the current or the number of turns of the coil; the magnitude of the magnetism may alternatively be controlled by changing a resistance to control the magnitude of the current; a magnetic pole of the electromagnet may be controlled by changing a direction of the current; and the like. That is, the strength of the magnetism may be changed, the presence or absence of the magnetism may be controlled, the direction of the magnetic pole may be changed, and the magnetism may disappear due to disappearance of the current.

One of the first magnetic force and the second magnetic force is an attractive force, and the other is a repulsive force. For example, when the first magnetic force is the attractive force and drives the valve stem head to move away from the nozzle orifice 33, the second magnetic force is the repulsive force and drives the valve stem head to move towards the nozzle orifice 33; and alternatively, when the first magnetic force is the repulsive force and drives the valve stem head to move away from the nozzle orifice 33, the second magnetic force is the attractive force and drives the valve stem head to move towards the nozzle orifice 33. This is specifically determined based on a relative position relationship between the first magnet 5 and the second magnet 6.

The current direction of the electromagnet is changed, to change the magnetic pole direction of the first magnet 5 or the second magnet 6, so that the first magnet 5 and the second magnet 6 attract each other, or repel each other. In this way, driven by the magnetic force between the first magnet 5 and the second magnet 6, the valve stem head moves towards and away from the nozzle orifice 33, and the magnetic force of the electromagnet drives the valve stem head to push the high-viscosity liquid to be jetted out. The present disclosure realizes the purpose of pushing high-viscosity liquid to be jetted out only by changing the current direction without changing a structure of the electromagnetic jetting device.

In a preferred implementation of this embodiment, both the first magnet 5 and the second magnet 6 are disposed outside the valve cavity 31.

Space inside the valve cavity 31 is small. Therefore, it is very difficult to accommodate and install the first magnet 5 and the second magnet 6. Moreover, if there is any problem after installation, it will be very difficult to disassemble. In addition, it is difficult for the coil to dissipate heat in the valve cavity and easy to be damaged. Therefore, both the first magnet 5 and the second magnet 6 are installed outside the valve cavity 31, to facilitate installation, maintenance, and adjustment, and sizes of the first magnet 5 and the second magnet 6 are not limited by the valve cavity.

In a preferred implementation of this embodiment, both the first magnet 5 and the second magnet 6 are electromagnets.

Both the first magnet 5 and the second magnet 6 are electromagnets, and the strength of the magnetic force and the magnetic field direction may be adjusted as required.

In a preferred implementation of this embodiment, the second magnet 6 is connected to the valve stem tail, the first magnet 5, the second magnet 6, and the valve stem 4 are sequentially disposed along the first direction, the first magnetic force is an attractive force, and the second magnetic force is a repulsive force.

The first magnet 5, the second magnet 6, and the valve stem 4 are sequentially disposed along the first direction. That is, the first magnet 5 is disposed on a side of the second magnet 6 away from the valve stem 4. In this case, when a direction of a current flowing through the electromagnet is a clockwise direction, the first magnet 5 and the second magnet 6 are the same in polarity and repel each other, to drive the valve stem head to move towards the nozzle orifice 33, and when the direction of the current flowing through the electromagnet is an anticlockwise direction, the first magnet 5 and the second magnet 6 are opposite in polarity and attract each other, to drive the valve stem head to move away from the nozzle orifice 33. A layout of the first magnet 5, the second magnet 6, and the valve stem 4 is more proper, and installation is easier.

In a preferred implementation of this embodiment, an elastic component 7 is further included, and an elastic resetting force of the elastic component 7 acts on the valve stem 4 and drives the valve stem 4 to move towards the nozzle orifice 33.

When the direction of the current flowing through the electromagnet is an anticlockwise direction, a second magnetic force is generated between the first magnet 5 and the second magnet 6 and drives the valve stem head to move away from the nozzle orifice 33, and the valve stem 4 drives the elastic component 7 to deform. When the direction of the current flowing through the electromagnet is a clockwise direction, a first magnetic force is generated between the first magnet 5 and the second magnet 6 and drives the valve stem head to move towards the nozzle orifice 33, and a resetting spring force of the elastic component 7 used for restoring the shape also drives the valve stem head to move towards the nozzle orifice 33. The elastic component 7 is disposed, and spring force and magnetic force jointly drive the valve stem head to push the high-viscosity liquid to be jetted out, thereby further ensuring that the highly-viscosity liquid can be jetted out.

In a preferred implementation of this embodiment, the elastic component 7 is a spring, the spring is sleeved over the valve stem 4 and is located in the valve cavity 31.

The elastic component 7 is set as a spring, and the spring is set in the valve cavity 31. The spring has a relatively large spring force and a relatively small volume, so that the electromagnetic jetting device is more compact.

In a preferred implementation of this embodiment, a sealing component 8 for sealing a gap between the valve stem 4 and the valve cavity 31 is disposed, the sealing component 8 separates the valve cavity 31 into a first cavity portion and a second cavity portion, the liquid inlet 32 and the nozzle orifice 33 communicate with the first cavity portion, and the spring is located in the second cavity portion.

The sealing component 8 is disposed to separate the valve cavity 31, so that it is not easy for the dispensing liquid to leak out. Specifically, the sealing component 8 is a sealing ring.

In a preferred implementation of this embodiment, the first magnet 5 is connected to the valve body 3 by using an adjustment component 9, and the adjustment component 9 adjusts a position of the first magnet 5 along the first direction.

A larger distance between the first magnet 5 and the second magnet 6 indicates a longer moving stroke of the second magnet 6 and the valve stem 4, and a smaller distance between the first magnet 5 and the second magnet 6 indicates a shorter moving stroke of the second magnet 6 and the valve stem 4. To be applicable to different moving strokes of the valve stem 4, the position of the first magnet 5 is set to be adjustable. Before being used, the electromagnetic jetting device first adjusts the position of the first magnet 5. During use, a relative position between the first magnet 5 and the valve body 3 remains unchanged. The adjustment component 9 may be, for example, a screw rod.

In a preferred implementation of this embodiment, the nozzle orifice 33 is disposed at one end of the valve cavity 31 in the first direction, the liquid inlet 32 is disposed at one end of the valve cavity 31 in the second direction, the liquid inlet 32 is close to the nozzle orifice 33, and the first direction and the second direction are perpendicular to each other.

The liquid inlet 32 is disposed on a side of a moving track of the valve stem 4, and the nozzle orifice 33 is disposed in front of the moving track of the valve stem 4. Therefore, when the valve stem 4 moves in a direction extending into the valve cavity 31, it is easier for the dispensing liquid to be jetted out from the nozzle orifice 33, and may not flow back to the liquid inlet 32. When the valve stem 4 moves, it is easier for the high-viscosity liquid to enter the valve cavity 31 and to be jetted out from the valve cavity 31.

In a preferred implementation of this embodiment, the valve stem head is in a shape of a bullet head, the nozzle orifice 33 is a conical bore, a tip of the valve stem head faces towards the nozzle orifice 33, and an opening of one end of the nozzle orifice 33 close to the valve stem head is larger than an opening of one end of the nozzle orifice 33 away from the valve stem head.

When being into contact with the dispensing liquid, the bullet head receives less resistance from the dispensing liquid, and it is easier to push the highly-viscosity liquid to the nozzle orifice 33. The nozzle orifice 33 is a taper bore with a large entrance, it is easier for the highly-viscosity liquid to enter the taper bore, and the taper bore guides the highly-viscosity liquid to be jetted out from a relatively small opening of the nozzle orifice.

Apparently, the embodiments are merely examples for clear description, and are not intended to limit the implementations. A person of ordinary skill in the art may make changes or variations in other different forms based on the description. All implementations do not need to be enumerated and cannot be enumerated herein. However, obvious changes or variations derived therefrom shall fall within the protection scope of the present disclosure.

What is claimed is:

1. An electromagnetic jetting device, comprising a support frame, a material cartridge, and an electromagnetic jetting valve, the material cartridge being connected to the support frame, and the material cartridge being configured to store dispensing liquid, wherein the electromagnetic jetting valve comprises:
a valve body, the valve body being connected to the support frame, the valve body being provided with a valve cavity extending along a first direction, the valve cavity having a liquid inlet and a nozzle orifice, the liquid inlet being configured for the dispensing liquid to enter the valve cavity, the liquid inlet communicating with the material cartridge, and the nozzle orifice being configured for the dispensing liquid in the valve cavity to be jetted out;
a valve stem, the valve stem extending along the first direction and comprising a valve stem head and a valve stem tail respectively close to two ends of the valve stem in a lengthwise direction, the valve stem head being located in the valve cavity, and the valve stem head being capable of moving towards and away from the nozzle orifice along the first direction; and
a driving assembly, the driving assembly comprising a first magnet and a second magnet, the first magnet being relatively fixed to the valve body, the second magnet being relatively fixed to the valve stem, and at least one of the first magnet and the second magnet being an electromagnet, wherein when a direction of a current flowing through the electromagnet is a clockwise direction, a first magnetic force is generated between the first magnet and the second magnet, and drives the valve stem to move away from the nozzle orifice, and when the direction of the current flowing through the electromagnet is an anticlockwise direction, a second magnetic force is generated between the first magnet and the second magnet, and drives the valve stem to move towards the nozzle orifice.

2. The electromagnetic jetting device according to claim 1, wherein both the first magnet and the second magnet are disposed outside the valve cavity.

3. The electromagnetic jetting device according to claim 1, wherein both the first magnet and the second magnet are electromagnets.

4. The electromagnetic jetting device according to claim 1, wherein the second magnet is connected to the valve stem tail, the first magnet, the second magnet, and the valve stem are sequentially disposed along the first direction, the first magnetic force is an attractive force, and the second magnetic force is a repulsive force.

5. The electromagnetic jetting device according to claim 1, wherein the driving assembly further comprises an elastic component, and an elastic resetting force of the elastic component acts on the valve stem and drives the valve stem to move towards the nozzle orifice.

6. The electromagnetic jetting device according to claim 5, wherein the elastic component is a spring, the spring is sleeved over the valve stem, and the spring is located in the valve cavity.

7. The electromagnetic jetting device according to claim 6, wherein a sealing component for sealing a gap between the valve stem and the valve cavity is disposed, the sealing component separates the valve cavity into a first cavity portion and a second cavity portion, the liquid inlet and the nozzle orifice communicate with the first cavity portion, and the spring is located in the second cavity portion.

8. The electromagnetic jetting device according to claim 1, wherein the first magnet is connected to the valve body by using an adjustment component, and the adjustment component adjusts a position of the first magnet along the first direction.

9. The electromagnetic jetting device according to claim 1, wherein the nozzle orifice is disposed at one end of the valve cavity in the first direction, the liquid inlet is disposed at one end of the valve cavity in a second direction, the liquid inlet is close to the nozzle orifice, and the first direction and the second direction are perpendicular to each other.

10. The electromagnetic jetting device according to claim 1, wherein the valve stem head is in a shape of a bullet head, the nozzle orifice is a conical bore, a tip of the valve stem head faces towards the nozzle orifice, and an opening of one end of the nozzle orifice close to the valve stem head is larger than an opening of one end of the nozzle orifice away from the valve stem head.
